(19) United States
(12) Patent Application Publication
(10) Pub. No.: US 2013/0288018 A1
(43) Pub. Date: Oct. 31, 2013

(54) SYSTEM AND METHOD FOR PRINTING ON PLASTIC AND FORMING THE PRINTED PLASTIC

(71) Applicant: Patrick W. Moller, Valencia, CA (US)

(72) Inventor: Patrick W. Moller, Valencia, CA (US)

(21) Appl. No.: 13/460,822

(22) Filed: Apr. 30, 2012

(51) Int. Cl. B32B 3/10; B29C 51/00

(52) U.S. Cl. 428/195.1; 425/150; 264/40.1

(57) ABSTRACT

Systems and methods for printing on a plastic substrate and forming the printed plastic substrate, and printed products thereof, are provided. A method for printing on a plastic substrate and forming the printed plastic substrate includes printing a printing medium to have a printed pattern on a surface of the plastic substrate; thermoforming the plastic substrate to have a shape using a thermoforming device; and indexing the plastic substrate to align the plastic substrate according to the printed pattern relative to the thermoforming device.

### FIELD

Aspects of embodiments of the present invention relate to a system and method for printing on plastic and forming the printed plastic, and printed products thereof.

### BACKGROUND

Thermoforming is a manufacturing process in which a plastic sheet or film is heated to a temperature at which it is pliable and is then formed in a mold to have a specific shape corresponding to the mold and cooled. After being formed in the mold, the plastic sheet is trimmed or cut to create a product. The plastic may be heated to a temperature, for example, at which the plastic sheet or film may be stretched onto the mold. The plastic sheet or film may be stretched over or into the mold using a vacuum or pressurized air. The mold is typically made of cast or machined aluminum, a composite or ceramic, or wood.

Thermoformed plastics account for nearly 33 billion dollars in total revenue in the United States. These thermoformed plastic products are used, in large part, in packaging products, such as in the delivery of fresh and frozen foods to consumers, given the contaminant protection that plastics offer, and also include disposable cups, containers, lids and trays, for example. The packaging products may be configured as blisters, clamshells, or other shapes. Typically, in thermoformed plastic packaging products, graphics are applied to the thermoformed plastics by the use of pressure-sensitive labels or paperboard cartons or sleeves. However, the use of a pressure-sensitive label or a paperboard carton or sleeve increases the material cost and manufacturing cost of the final product. For example, typically, the pressure-sensitive labels are manually applied to the plastic. Additionally, the pressure-sensitive labels typically include an adhesive which renders the plastic unrecyclable, which increases disposal costs and has a negative environmental impact.

Various printing methods are commonly used for printing on paper, including offset lithography, flexography, and rotogravure. Offset lithography is a printing process in which an image is transferred, or offset, from a plate to a blanket, and then to a printing surface. Utilizing the property of repulsion between oil and water, offset lithography uses an offset image plate or drum on which the image to be printed picks up a layer of ink, while a non-printing area attracts a water-based film. Flexography is a printing process that utilizes a flexible printing plate, whereby a print is made by creating a positive mirrored master of the required image as a three-dimensional relief in a rubber or polymer material. Flexography can be used with water-based inks and is used for printing on various materials, including plastics. Rotogravure is a printing process in which ink is applied to an engraved cylinder and transferred from the cylinder directly to the substrate in a rotary printing press. The rotogravure cylinder has cells of various size engraved therein and, therefore, is capable of printing images having a great density range. However, efforts to print directly on plastics suitable for thermoforming have resulted in very little success. In view of the above, it would be desirable to print directly on a plastic that could subsequently be thermoformed to have a desired shape.

### SUMMARY

According to an aspect of embodiments of the present invention, a system and method of directly printing on a plastic and thermoforming the printed plastic reduces cost by eliminating the need for pressure-sensitive labels or paperboard cartons or sleeves. According to another aspect of embodiments of the present invention, a system and method of directly printing on a plastic and thermoforming the printed plastic reduces negative environmental impact due to the printed plastic product being recyclable.

According to an aspect of embodiments of the present invention, a system and method of directly printing on a plastic and thermoforming the printed plastic include a roll-to-roll process of printing on a plastic substrate via offset lithography, aligning the printed plastic substrate with respect to a thermoforming device, and thermoforming the printed plastic substrate to have a desired shape. According to another aspect of embodiments of the present invention, a method of directly printing on a plastic and thermoforming the printed plastic includes registering a printed pattern on a plastic substrate based on a formed shape of the thermoformed plastic substrate.

According to one embodiment of the present invention, a system for printing on a plastic substrate and forming the printed plastic substrate includes: a printing device configured to print a printing medium on the plastic substrate to have a printed pattern; a thermoforming device configured to thermoform the plastic substrate to have a shape; and an indexing device to align the plastic substrate according to the printed pattern relative to the thermoforming device.

In one embodiment, the printing device includes an offset lithography device. The offset lithography device may include a printing blanket configured to transfer the printing medium to the plastic substrate, the printing blanket having a durometer of 65 to 79 Shore A.

In one embodiment, the system further includes an unwinding section configured to supply the plastic substrate from a supply roll; and a winding section configured to wind the plastic substrate to a take-up roll, the printing device being arranged between the unwinding section and the winding section, and the system being configured to move the plastic substrate from the unwinding section to the winding section at a substantially constant rate.

The system may further include a feeding section configured to feed the plastic substrate to the thermoforming device.

In one embodiment, the indexing device is configured to detect a timing mark on the plastic substrate that corresponds to the printed pattern and to stop a movement of the plastic substrate relative to the thermoforming device in response to detecting the timing mark.

According to another embodiment of the present invention, a method of printing on a plastic substrate and forming the printed plastic substrate includes: printing a printing medium to have a printed pattern on a surface of the plastic substrate; thermoforming the plastic substrate to have a shape using a thermoforming device; and indexing the plastic substrate to align the plastic substrate according to the printed pattern relative to the thermoforming device.

In one embodiment, printing the printing medium on the plastic substrate includes using an offset lithography device. Printing the printing medium on the plastic substrate may further include transferring the printing medium to the plastic substrate using a printing blanket of the offset lithography device, the printing blanket having a durometer of 65 to 79 Shore A.

In one embodiment, during the thermoforming the plastic substrate to have the shape, the printed pattern is shaped to have a shaped pattern associated with the shape of the plastic substrate, and the method further includes registering the printed pattern to the thermoforming device, the registering including: printing the printing medium to have a test printed pattern on a surface of a test plastic substrate; thermoforming the test plastic substrate to have the shape using the thermoforming device, wherein, during the thermoforming the test plastic substrate to have the shape, the test printed pattern is shaped to have a test shaped pattern; analyzing the test shaped pattern; and adjusting a database to print the printed pattern on the plastic substrate based on the test shaped pattern. The test printed pattern may include grid lines.

In one embodiment, the method further includes: supplying the plastic substrate from a supply roll prior to printing the printing medium on the plastic substrate; winding the plastic substrate to a take-up roll subsequent to printing the printing medium on the plastic substrate; and moving the plastic substrate from the supply roll to the take-up roll at a substantially constant rate. The method may further include feeding the plastic substrate from the take-up roll to the thermoforming device.

In one embodiment, indexing the plastic substrate includes: printing a timing mark on the plastic substrate relative to the printed pattern; detecting the timing mark; and stopping a movement of the plastic substrate relative to the thermoforming device in response to detecting the timing mark.

In one embodiment, a dyne level of the plastic substrate is greater than 40 dyn/cm.

According to another embodiment of the present invention, a printed plastic object includes: a plastic substrate; and a printed portion printed directly on a surface of the plastic substrate, and the plastic substrate having the printed portion printed directly thereon is thermoformed to have a shape.

The printed portion may include an ink having a thickness of 5 μm or less. The printed plastic object may include a packaging cover.

In one embodiment, a dyne level of the plastic substrate is greater than 40 dyn/cm.

In one embodiment, a thickness of the plastic substrate is 0.015 to 0.030 inches.

The plastic substrate may include a material selected from the group consisting of polyethylene terephthalate (PET), oriented polystyrene (OPS), styrene, polyvinyl chloride (PVC), and polypropylene.

Other features and advantages of the present invention will become more apparent from the following detailed description, taken in conjunction with the accompanying drawings which illustrate, by way of example, features and aspects of some exemplary embodiments of the present invention.

### BRIEF DESCRIPTION OF THE DRAWINGS

The above and other features, aspects, and advantages of the present invention will become better understood with regard to the following description, appended claims, and accompanying drawings where:

FIG. 1A is a schematic diagram of a printing portion of a system for printing on plastic and forming the printed plastic according to an embodiment of the present invention;

FIG. 1B is a schematic diagram of a forming portion of the system for printing on plastic and forming the printed plastic of FIG. 1A;

FIG. 2 is a schematic side view of an offset lithography apparatus of the system of FIGS. 1A and 1B, according to an embodiment of the present invention;

FIG. 3 is a perspective view of a printed plastic object according to an embodiment of the present invention;

FIG. 4 is a flowchart showing tasks of a method for printing on plastic and forming the printed plastic, according to an embodiment of the present invention;

FIG. 5 is a schematic perspective view of a plastic substrate, shown in an unformed state, including a test pattern, according to an embodiment of the present invention; and

FIG. 6 is a schematic perspective view of the plastic substrate of FIG. 5, shown in a formed state, including the test pattern.

### DETAILED DESCRIPTION

In the following detailed description, certain exemplary embodiments of the present invention are shown and described, by way of illustration. As those skilled in the art would recognize, the described exemplary embodiments may be modified in various ways without departing from the spirit and scope of the present invention. Accordingly, the drawings and description are to be regarded as illustrative in nature, rather than restrictive.

According to embodiments of the present invention, a system and method of directly printing on a plastic (e.g., a plastic substrate) and then thermoforming the printed plastic (i.e. the plastic having the printed matter printed directly thereon) are provided, such that cost and manufacturing steps may be reduced. That is, embodiments of the present invention described herein are directed to systems and methods for printing on plastic and forming the printed plastic, or print to plastic to form, and printed products thereof.

Print to plastic to form according to an exemplary embodiment of the present invention is based upon roll web printing, one of the most efficient printing methods within the printing industry. According to an exemplary embodiment of the present invention, the process of printing to a plastic substrate is a roll-to-roll process in which the plastic substrate in an unprinted state is unwound from a supply roll and is wound in a printed state onto a take-up roll.

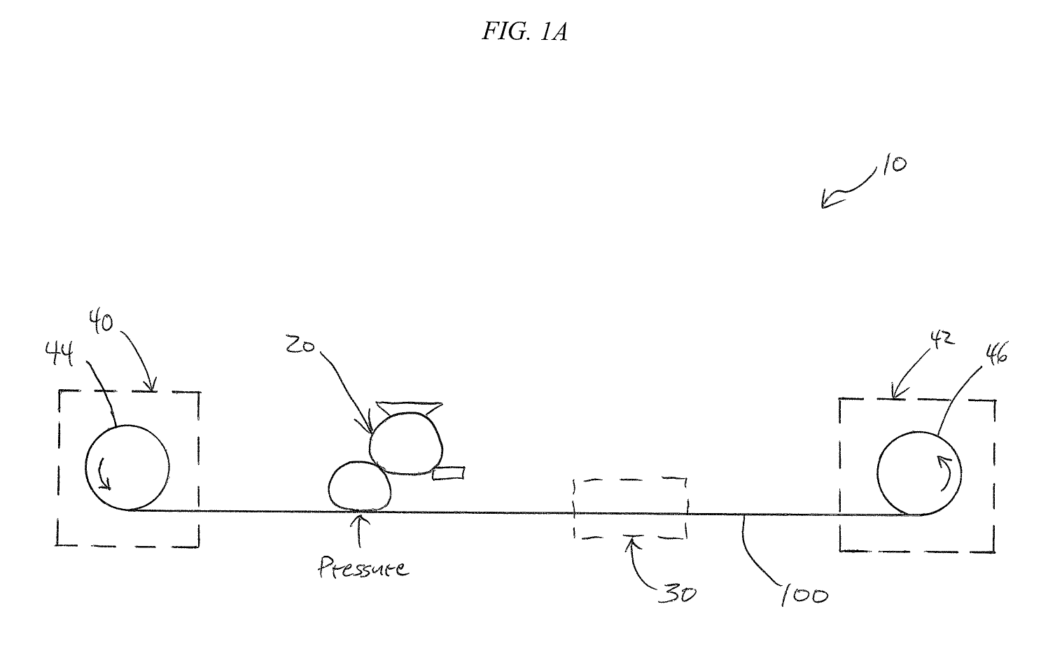

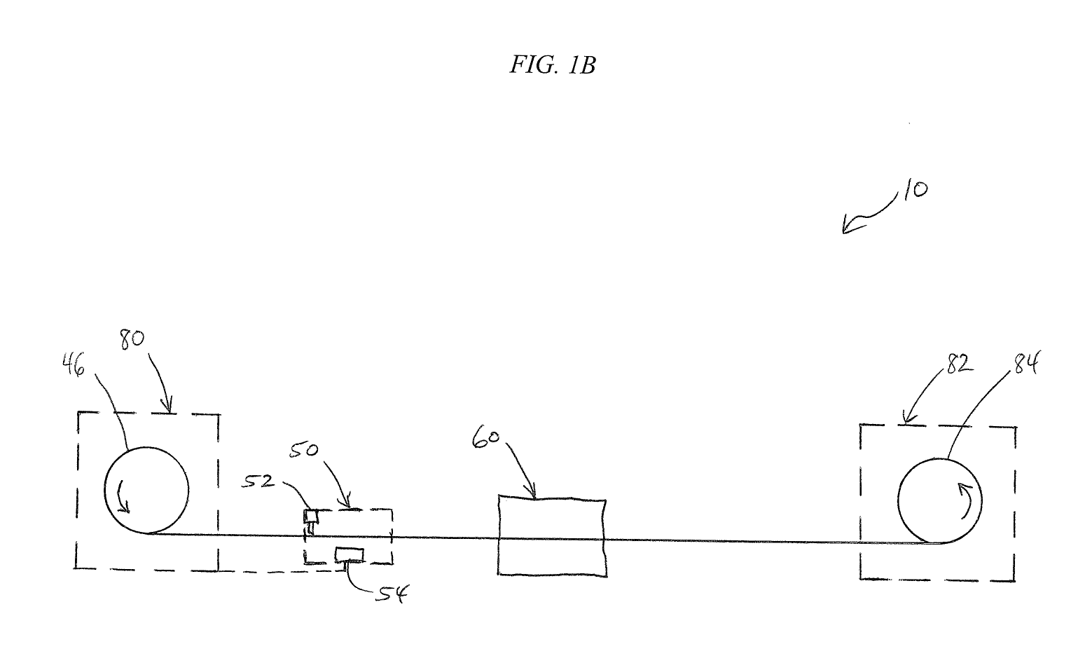

With reference to FIGS. 1A and 1B, a system 10 for printing on plastic and forming the printed plastic according to one exemplary embodiment of the present invention includes a printing portion (see FIG. 1A) and a forming portion (see FIG. 1B).

As shown in FIG. 1A, the system 10 according to one embodiment includes a printing device 20, a curing section 30, an unwinding section 40 to supply a plastic substrate 100 to the printing device 20, and an intermediate winding section 42 to receive the plastic substrate 100 in a printed state from the curing section 30.

The unwinding section 40 is configured to supply the plastic substrate 100, such as in a web or film, from a supply roll 44 to the printing device 20. The unwinding section 40 may include one or more rollers, motors, or other suitable devices for supplying the plastic substrate 100 from the supply roll 44 to the printing device 20. The winding section 42 is configured to wind the plastic substrate 100 in a printed state from the curing section 30 to an intermediate take-up roll 46. The winding section 42 may include one or more rollers, motors, or other suitable devices for winding the plastic substrate 100 to the intermediate take-up roll 46. The system 10 may further include one or more rollers, motors, or other suitable devices at one or more locations between the unwinding section 40 and the winding section 42 for moving or feeding the plastic substrate 100 from the supply roll 44 to the intermediate take-up roll 46. The system 10 may be configured to move the plastic substrate 10 from the unwinding section 40 to the intermediate winding section 42 at a constant or substantially constant rate.

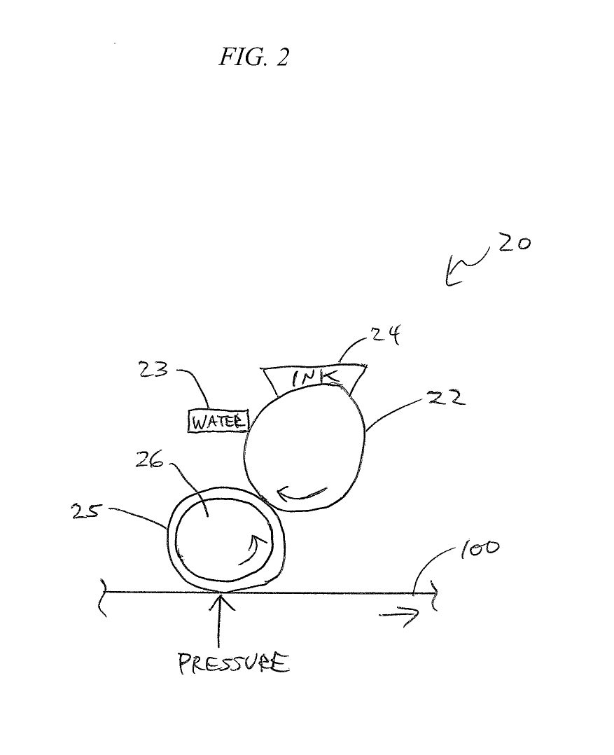

With reference to FIG. 2, the printing device 20 according to one embodiment is an offset lithography apparatus configured to print on the plastic substrate 100, such as in a high-speed roll-to-roll process. However, in other embodiments of the present invention, the printing device 20 may be a flexography or rotogravure printing device. As depicted in FIG. 2, in the offset lithography apparatus, a first plate 22 or drum (e.g., an aluminum-based plate) is digitally “exposed” to create a four color process (CMYK) and/or many other colors using the PMS (Pantone) color system that is known in the art. The process uses a simple “water and oil do not mix” capability to place a very thin film of water on the first plate 22 that is immediately dispersed when in contact with the exposed image on the first plate 22 required for a given color. The first plate 22 comes in contact with a water source 23 to place the film of water on the first plate 22. Then the first plate 22 comes in contact with an ink source 24 and the exposed area is “inked” with the desired color. That image is transferred to a printing blanket 25, similar to a hard sponge, which takes up the offset image. The printing blanket 25 may be arranged on a transfer plate 26 or drum and transfers the image to the plastic substrate 100. As the plastic substrate 100 is not perfectly flat, the hardness or durometer of the printing blanket 25 is specific to printing on thermoformable plastics. The printing blanket 25 is configured to transfer the printing medium to the plastic substrate 100 and, in an exemplary embodiment, has a durometer of 65 to 79 Shore A.

While FIG. 1A depicts only one printing device 20, the system 10 may include a plurality of the printing devices 20 configured to print one or more printing mediums on the plastic substrate 100 to have one or more patterns. For example, the plurality of printing devices 20 may be configured to print a plurality of layers, such as serially along a length of the plastic substrate 100 and/or concurrently along a width of the plastic substrate 100.

The curing section 30 may include an electron beam (EB) curing device that is configured to cure one or more layers of the printing medium while the plastic substrate 100 is moved from the printing device 20 to the intermediate take-up roll 46.

With reference to FIG. 1B, the system 10 according to one embodiment further includes an indexing device 50, a thermoforming and extracting device 60, an intermediate unwinding section 80 to supply the plastic substrate 100 in a printed state to the indexing device 50, and a winding section 82 to receive a remaining unformed portion of the plastic substrate 100 from the thermoforming and extracting device 60.

The intermediate unwinding section 80, or feeding section, is configured to supply the plastic substrate 100 having the printed pattern from the intermediate take-up roll 46 to the indexing device 50. The intermediate unwinding section 80 may include one or more rollers, motors, or other suitable devices for supplying the plastic substrate 100 having the printed pattern from the intermediate take-up roll 46 to the indexing device 50. The winding section 82 is configured to receive the remaining unformed portion of the plastic substrate 100 from the thermoforming and extracting device 60 and wind the remaining unformed portion of the plastic substrate 100 to a take-up roll 84. The winding section 82 may include one or more rollers, motors, or other suitable devices for winding the remaining unformed portion of the plastic substrate 100 to the take-up roll 84. The system 10 may further include one or more rollers, motors, or other suitable devices at one or more locations between the intermediate unwinding section 80 and the winding section 82 for moving or feeding the plastic substrate 100 from the intermediate take-up roll 46 to the take-up roll 84. The system 10 may be configured to move the plastic substrate 10 from the intermediate unwinding section 80 to the winding section 82 at a constant or substantially constant rate.

The indexing device 50 according to one embodiment receives the plastic substrate 100 from the intermediate take-up roll 46. The indexing device 50 is configured to index or align the plastic substrate 100 having the printed pattern with the thermoforming and extracting device 60. In this manner, the printed pattern and a portion of the plastic substrate 100 that is formed to have a shape will be aligned. The indexing device 50 according to one embodiment includes a sensor 52 (e.g., a light beam sensor) to recognize a timing mark printed on the plastic substrate 100 in spatial relation to the printed pattern. The indexing device 50 may further include a controller 54 to start/stop feeding of the plastic substrate 100 from the intermediate unwinding section 80 to the thermoforming and extracting device 60 in response to the sensor 52 detecting the timing mark to properly align the printed pattern of the plastic substrate 100 with a mold or die of the thermoforming and extracting device 60. The indexing device 50 according to one embodiment may be configured to index the plastic substrate 100 relative to the thermoforming and extracting device 60 in a lengthwise direction and/or a widthwise direction of the plastic substrate 100.

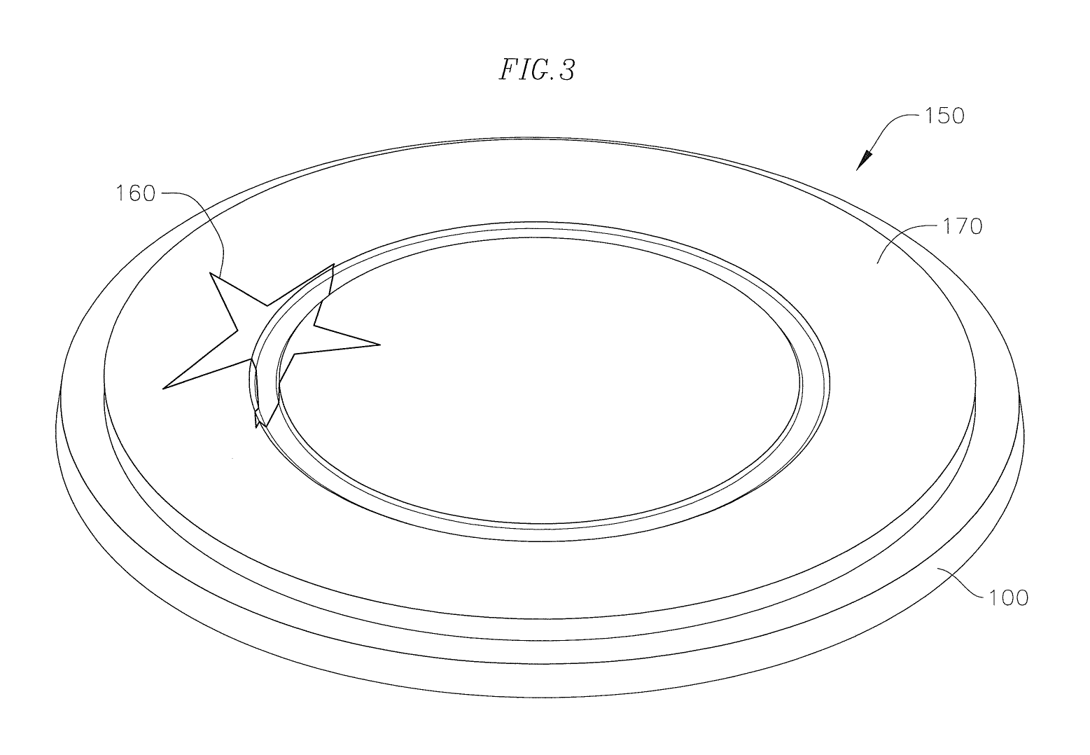

The thermoforming and extracting device 60 is configured to form the plastic substrate 100 to have a shape. More specifically, because the indexing device 50 aligns the printed pattern on the plastic substrate 100 with the thermoforming and extracting device 60, the thermoforming and extracting device 60 forms a printed portion of the plastic substrate 100 to have a shape. The thermoforming and extracting device 60 includes a mold or die, such as male and female dies, and may use a vacuum to engage the plastic substrate 100 in the mold (e.g., by pushing or pulling). The thermoforming and extracting device 60 is configured to heat the plastic substrate 100 to a formable temperature which is specific to the material of the plastic substrate 100. After the plastic substrate 100 is formed in the mold to have a shape, a portion (e.g., a printed portion having the shape, such as a printed object described later herein with respect to FIG. 3) is released from the mold and may be extracted from the unformed portion of the web. The remaining unformed portion of the plastic substrate 100 may then be wound to the take-up roll 84.

According to an exemplary embodiment of the present invention, as described above and depicted in FIGS. 1A and 1B, the plastic substrate 100 in the printed state is wound on the intermediate take-up roll 46 and subsequently unwound from the intermediate take-up roll 46 and supplied therefrom to the indexing device 50. However, the present invention is not limited thereto and, in another embodiment, the intermediate winding section 42, the intermediate take-up roll 46, and the intermediate unwinding section 80 may be omitted. That is, in another embodiment, the plastic substrate 100 in a printed state may be supplied from the printing device 20 to the indexing device 50 without first being wound.

The plastic substrate 100 may be formed as a sheet, a film, a web, an extrusion, or any other suitable substrate configuration. The plastic substrate 100 may include a material selected from the group consisting of polyethylene terephthalate (PET), oriented polystyrene (OPS), styrene, polyvinyl chloride (PVC), and polypropylene. However, the present invention is not limited thereto and, in other embodiments, the plastic substrate 100 may include any other suitable material such as, but not limited to, PLAs, bioplastics, or materials derived from plant materials.

Typically, paper and plastic have had to be sheeted to various sizes in order to be printed. In the packaging industry, there is a broad range of printing equipment currently in use to produce higher caliper printed paper. High caliper is defined as a thickness of 0.008 inches or greater. Thermoforming may be performed on a material having a caliper of 0.008 inches or greater. A material having a caliper of less than 0.008 inches cannot be easily formed or used. According to embodiments of the present invention, when the raw, yet printable plastics are used, with correct ink formulations, then the printing process and nearly all graphic requirements can be directly printed on the roll-to-roll thermoforming-grade plastics.

The plastic substrate 100, in one embodiment, is formed as a web having a width and a thickness. In one embodiment, the plastic substrate 100 has a thickness of 0.015 to 0.030 inches. The width of the plastic substrate 100 may be any suitable width and, in one embodiment, may be 24 to 49.5 inches, for example. Further, in one embodiment, the plastic substrate 100 has a length which may be wound on a roll.

According to an exemplary embodiment of the present invention, the plastic substrate 100 has three properties. The first property of the plastic substrate 100 is a consistent or substantially consistent flatness across the web. The second property of the plastic substrate 100 is a dyne level greater than 40 dyn/cm. The dyne level of the plastic substrate 100 affects the ability of the ink to wet out properly, that is, to keep its intended size when printed, and to adhere to the plastic substrate 100 through the thermoforming process and the eventual use of the final thermoformed product. The dyne level is an inherent surface energy of a material. Some plastics are characterized by chemically inert and nonporous surfaces with low surface energies, resulting in poor bonding with printing inks. That is, the dyne level of the plastic substrate 100 is correlated with a degree to which the surface of the plastic substrate 100 is wettable by the ink. In one embodiment, before the printing is performed on the plastic substrate 100, the dyne level of the plastic substrate 100 may be increased to the desired level by any suitable device or method, such as Corona treatment. The third property of the plastic substrate 100 is a consistent caliper, or thickness. Cast extruded plastic used in thermoforming may have “gauge bands” along a direction of a web. The bands may be lower or higher than an adjacent band, which may be compensated for by the durometer of the printing blanket 25 described above. According to an exemplary embodiment of the present invention, the plastic substrate 100 does not have bands that are lower or higher than an adjacent band by more than 0.005 inches. Therefore, the materials are specified for flatness, dyne level, and printability.

With reference to FIG. 3, a printed plastic object 150 according to an embodiment of the present invention is printed and thermoformed using the system 10 described above. That is, the printed plastic object 150 is made according to print to plastic to form according to the present invention. The printed plastic object 150 includes the plastic substrate 100 and a printed portion 160 printed directly on a surface of the plastic substrate 100. In one embodiment, the printed portion 160 is made up of a printed ink having a thickness of 5 μm or less. The printed portion 160 may be printed having a linescreen of 175 lines per inch or more in both directions. Further, in one embodiment, the printed portion 160 may be printed without an ink halo using an offset lithography device. However, in another embodiment of the present invention, the printed portion 160 may be printed using a flexography or rotogravure device.

The plastic substrate 100 having the printed portion 160 printed directly thereon is thermoformed to have a shape. For example, the shape may include a flange 170 or other protrusion, a cavity or recess, or any other desired shaped feature, or a combination thereof. The printed plastic object 150 is depicted in FIG. 3 as a packaging cover, but in other embodiments may be a container, a display product, or any other desired object having a printed portion and being formed to have a shape. In one embodiment, a dyne level of the plastic substrate 100 is greater than 40 dyn/cm. The plastic substrate 100 according to one embodiment may have a thickness of 0.015 to 0.030 inches. Further, the plastic substrate 100 may be a polyethylene terephthalate (PET), oriented polystyrene (OPS), styrene, polyvinyl chloride (PVC), or polypropylene substrate.

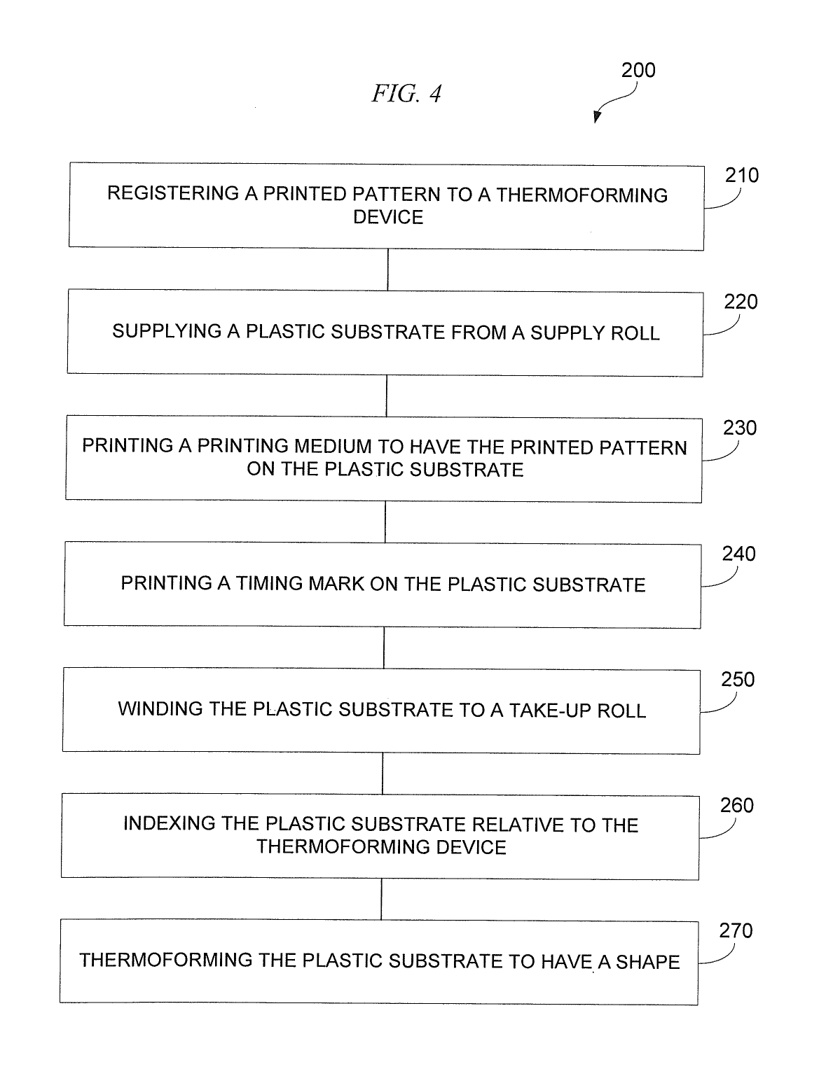

With reference to FIG. 4, tasks of a method 200 for printing on plastic and forming the printed plastic are shown. While the method 200 is described herein with respect to the system 10 for printing on plastic and forming the printed plastic described above and shown in FIGS. 1A and 1B, the method 200, or at least some of the tasks thereof, may be performed using systems for printing on plastic and forming the printed plastic according to other embodiments of the present invention.

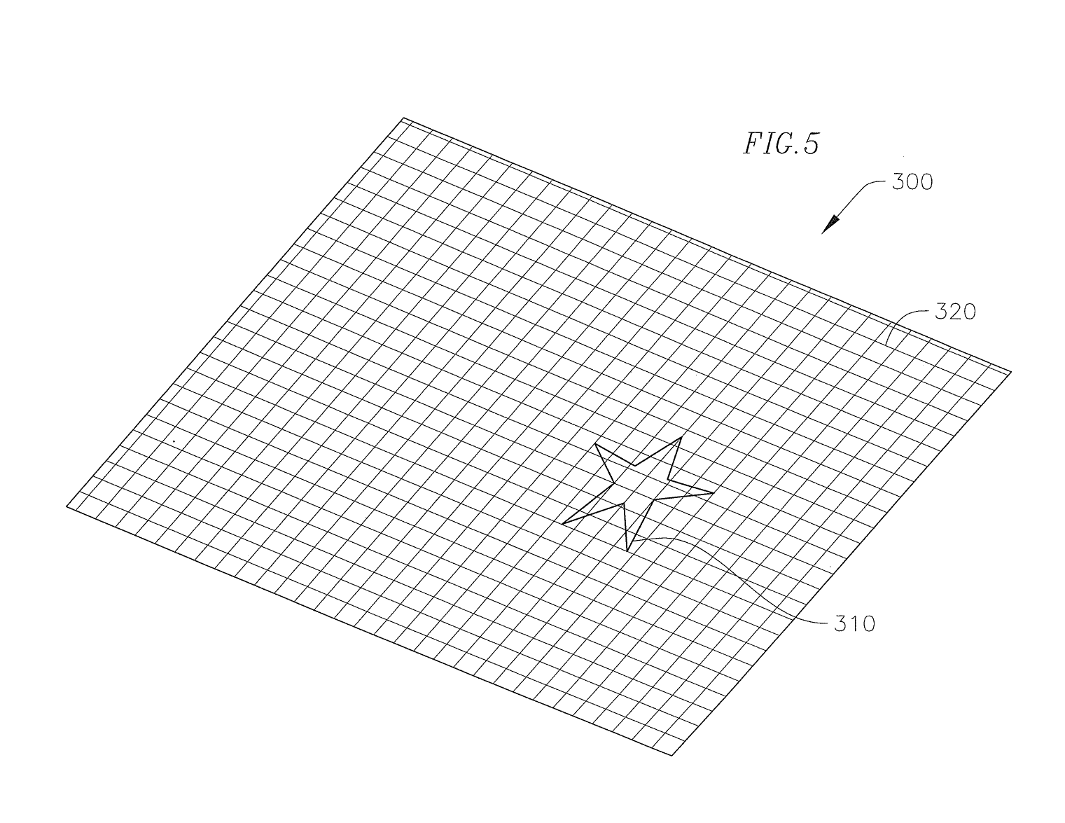

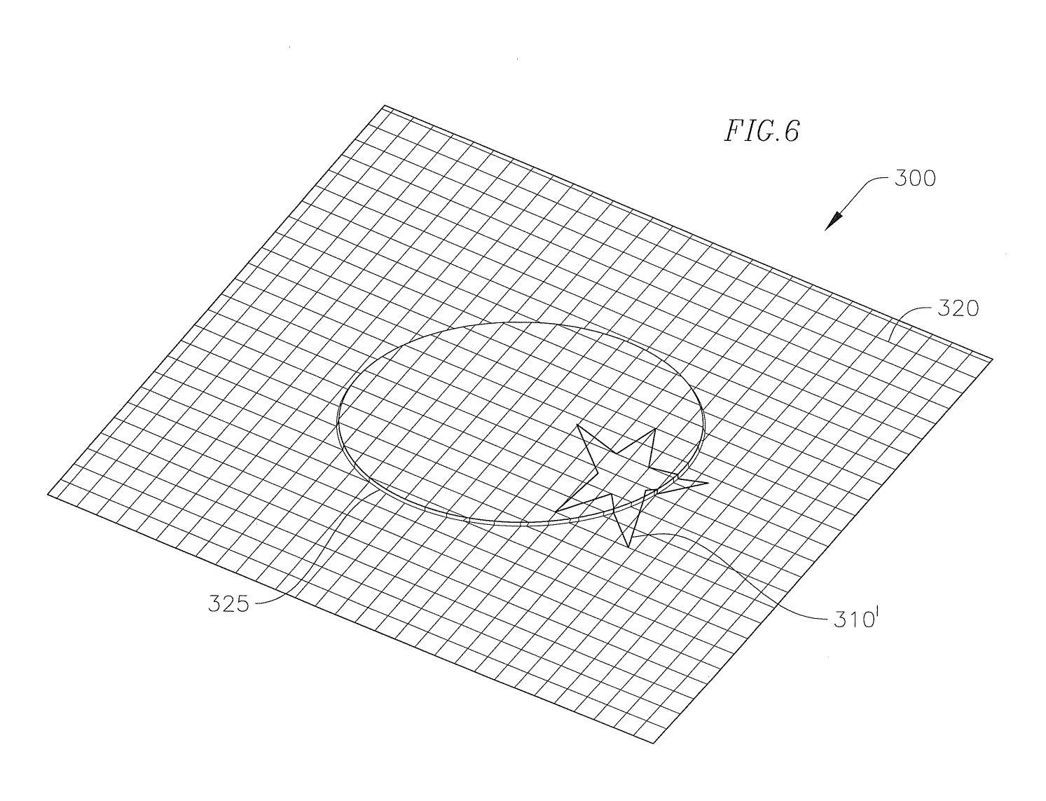

With reference to FIG. 4, in one embodiment, the method 200 includes a task 210 of registering a printed pattern to a thermoforming device. Because a rolling of the plastic substrate 100 and an indexing of the plastic substrate 100 are performed concurrently and, also, during the thermoforming process, the printed pattern is shaped to have a shaped pattern associated with the formed shape of the plastic substrate 100, the printed pattern must be registered to the thermoforming and extracting device 60. The task 210 of registering the printed pattern to the thermoforming and extracting device 60 is further described later herein with reference to FIGS. 5 and 6.

The method 200, in one embodiment, further includes a task 220 of supplying the plastic substrate 100 from the supply roll. The plastic substrate 100 is supplied by the unwinding section from the supply roll 44 to the printing device 20. According to one embodiment, the plastic substrate 100 is supplied or fed at a constant or substantially constant rate.

The method 200 according to one embodiment further includes a task 230 of printing a printing medium to have a printed pattern on a surface of the plastic substrate 100. The printing medium may be an ink that is capable of meeting the first plate 22, the printing blanket 25, and the plastic substrate 100. Further, the ink may be a malleable ink that is capable of being stretched (e.g., stretched by 50%) without cracking. In one embodiment, the ink has a thickness of 5 μm or less. The printed portion 160 may be printed having a linescreen of 175 lines per inch or more in both directions. The printed pattern may include lettering, an advertising message, a design, an image, or any other desired pattern to be printed on the plastic substrate 100. In one embodiment, the task 230 of printing on the plastic substrate 100 is performed using the printing device 20 which, in one embodiment, is an offset lithography device as shown in FIG. 2. However, in other embodiments of the present invention, the printing device 20 may be a flexography or rotogravure printing device. In one embodiment, the printing medium that is printed on the plastic substrate 100 is cured while the roll-to-roll process maintains a substantially constant speed. The printing medium (e.g., the ink) may be cured by electron beam (EB) curing, for example. Further, the task 230 of printing the printing medium to have the printed pattern may include printing a plurality of layers (e.g., serially along a length of the plastic substrate 100 and/or concurrently along a width of the plastic substrate 100) using one or more of the printing devices 20. The multiple layers may include different colors of ink, for example. Further, the multiple layers may be cured together.

The method 200, in one embodiment, further includes a task 240 of printing a timing mark on the plastic substrate 100. In order for the thermoforming equipment to index properly and align the tool with the printing, common eye mark technology may be used. A timing mark is printed relative to the multiple-cavity image in order to index (i.e. start/stop) the plastic substrate 100 in the thermoforming process. A second width timing mark may be used with appropriate web guiding capability to keep the plastic substrate 100 in position throughout the thermoforming process.

The method 200, in one embodiment, further includes a task 250 of winding the plastic substrate 100 to a take-up roll. In one embodiment, the plastic substrate 100 is wound by the intermediate winding section 42 to the intermediate take-up roll 46. That is, the take-up roll is the intermediate take-up roll 46 that is subsequently unwound and fed to the indexing device 50 and the thermoforming and extracting device 60. In another embodiment, as described above, the intermediate take-up roll 46 may be omitted, and an remaining unformed portion of the plastic substrate 100 may be wound to the take-up roll 84. According to one embodiment, the plastic substrate 100 is wound at a constant or substantially constant rate.

The method 200, in one embodiment, further includes a task 260 of indexing the plastic substrate 100 relative to the thermoforming and extracting device 60. The index is the run length per tool form. As discussed above, in the task 240, a timing mark is printed relative to the printed pattern of the plastic substrate 100. In the task 260, the timing mark is used to index (i.e. start/stop) the plastic substrate 100 in the thermoforming process. A second width timing mark may be used with appropriate web guiding capability to maintain the plastic substrate 100 in position throughout the thermoforming process.

The method 200, in one embodiment, further includes a task 270 of thermoforming the plastic substrate 100 to have a shape using the thermoforming and extracting device 60. Thermoforming is performed by raising the internal and external temperature, or heating, of the plastic substrate 100 to its malleable or formable temperature. This temperature is specific to the material of the plastic substrate 100. For example, common PET generally must be heated to about 210° C. to become thermoformable. A vacuum may be used to engage the plastic substrate 100 in a mold or die of the thermoforming and extracting device 60 (e.g., by pushing or pulling). After the plastic substrate 100 is formed in the mold to have a shape, it is released from the mold and may be extracted from the unformed portion of the web. In the task 270 of thermoforming the plastic substrate 100, a portion (e.g., the flange 170 of the printed plastic object 150 described above with respect to FIG. 3) of a first surface may be protruded away from an adjacent portion of the first surface. For example, the portion may be protruded away from the adjacent portion to form a stepped region. Further, in the task 270 of thermoforming the plastic substrate 100, the plastic substrate 100 may be stretched at the stepped region.

While in one embodiment, the method 200 for printing on plastic and forming the printed plastic may include each of the tasks described above and shown in FIG. 4, in other embodiments of the present invention, in a method for printing on plastic and forming the printed plastic, one or more of the tasks described above and shown in FIG. 4 may be absent and/or additional tasks may be performed. Further, in the method 200 for printing on plastic and forming the printed plastic according to one embodiment, the tasks may be performed in the order depicted in FIG. 4. However, the present invention is not limited thereto and, in a method for printing on plastic and forming the printed plastic according to other embodiments of the present invention, the tasks described above and shown in FIG. 4 may be performed in any other suitable sequence.

With reference to FIGS. 5 and 6, the task 210 of registering a printed pattern to a thermoforming device includes printing a test printed pattern 310 on a test plastic substrate 300, forming the test plastic substrate 300 having the test printed pattern 310 printed thereon, and analyzing the shaped test pattern 310. The test plastic substrate 300 is shown in FIG. 5 in an unformed state and having the test printed pattern 310 printed thereon. The test plastic substrate 300 is shown in FIG. 6 in a formed state, including the test printed pattern 310 that has become a test shaped pattern 310′ due to the thermoforming process. That is, in FIG. 6, the test plastic substrate 300 has a formed shape, such as a flange 325 or other protrusion or shaped portion which stretches or modifies the test printed pattern 310 to become the test shaped pattern 310′. The test plastic substrate 300 is shown in FIGS. 5 and 6 having grid lines 320. As depicted in FIG. 6, the grid lines 320 are also stretched or modified by the flange 325 or other protrusion or shaped portion.

According to one embodiment, registering the printed pattern to the thermoforming and extracting device 60 includes printing the printing medium to have the test printed pattern 310 on a surface of the test plastic substrate 300; thermoforming the test plastic substrate 300 to have the shape using the thermoforming and extracting device 60 such that during thermoforming the test plastic substrate 300 to have the shape, the test printed pattern 310 is shaped to have a test shaped pattern 310′. The test shaped pattern 310′ is analyzed and a database to print the printed pattern on the plastic substrate 100 based on the test shaped pattern 310′ is adjusted. The grid lines 320 may be provided with the test printed pattern 310 prior to thermoforming the test plastic substrate 300 to facilitate the analyzing of the test shaped pattern 310′.

The first step in the registration process is to receive a computer-aided design (CAD), similar to a die CAD being received in common package printing. A test roll may be provided from the printer with grid lines printed on the test roll to determine how the printing of the plastic substrate 100 will react to the thermoforming mold, such as a multiple-cavity mold. In thermoforming, a multiple-cavity mold may be used for improved efficiency. Once the variations of the overall multiple-cavity mold are determined, the printer can easily place each print image in the correct printing area of the width and repeat of printing. Distortion of the image may be desired such that when the plastic is formed and stretched, the image appears of good graphic quality. Therefore, in one embodiment, the simplified steps of registering the printed pattern to the thermoforming and extracting device 60 are: receipt of the CAD of the tool; layout of the image of each cavity to the press form (width and repeat length); correction, after forming grid-printed thermoforming test plastic substrate of same grade and caliper; and final printing.

Although the drawings and accompanying description illustrate some exemplary embodiments of systems and methods for printing on plastic and forming the printed plastic, it will be apparent that the novel aspects of the present invention may also be carried out by utilizing other structures, sizes, shapes, and/or materials in embodiments of the present invention instead of or in addition to those described above and shown in the drawings.

The preceding description has been presented with reference to various embodiments of the invention. Persons skilled in the art and technology to which this invention pertains will appreciate that alterations and changes in the described structures and methods of operation can be practiced without meaningfully departing from the principles, spirit, and scope of this invention.

What is claimed is:

1. A system for printing on a plastic substrate and forming the printed plastic substrate, the system comprising:
a printing device configured to print a printing medium on the plastic substrate to have a printed pattern;
a thermoforming device configured to thermoform the plastic substrate to have a shape; and
an indexing device to align the plastic substrate according to the printed pattern relative to the thermoforming device.

2. The system of claim 1, wherein the printing device comprises an offset lithography device.

3. The system of claim 2, wherein the offset lithography device comprises a printing blanket configured to transfer the printing medium to the plastic substrate, the printing blanket having a durometer of 65 to 79 Shore A.

4. The system of claim 1, further comprising:
an unwinding section configured to supply the plastic substrate from a supply roll; and
a winding section configured to wind the plastic substrate to a take-up roll,
wherein the printing device is arranged between the unwinding section and the winding section, and
wherein the system is configured to move the plastic substrate from the unwinding section to the winding section at a substantially constant rate.

5. The system of claim 1, further comprising a feeding section configured to feed the plastic substrate to the thermoforming device.

6. The system of claim 1, wherein the indexing device is configured to detect a timing mark on the plastic substrate that corresponds to the printed pattern and to stop a movement of the plastic substrate relative to the thermoforming device in response to detecting the timing mark.

7. A method of printing on a plastic substrate and forming the printed plastic substrate, the method comprising:
printing a printing medium to have a printed pattern on a surface of the plastic substrate;
thermoforming the plastic substrate to have a shape using a thermoforming device; and
indexing the plastic substrate to align the plastic substrate according to the printed pattern relative to the thermoforming device.

8. The method of claim 7, wherein printing the printing medium on the plastic substrate comprises using an offset lithography device.

9. The method of claim 8, wherein printing the printing medium on the plastic substrate further comprises transferring the printing medium to the plastic substrate using a printing blanket of the offset lithography device, the printing blanket having a durometer of 65 to 79 Shore A.

10. The method of claim 7,
wherein, during the thermoforming the plastic substrate to have the shape, the printed pattern is shaped to have a shaped pattern associated with the shape of the plastic substrate, and
wherein the method further comprises registering the printed pattern to the thermoforming device, the registering comprising:
printing the printing medium to have a test printed pattern on a surface of a test plastic substrate;
thermoforming the test plastic substrate to have the shape using the thermoforming device, wherein, during the thermoforming the test plastic substrate to have the shape, the test printed pattern is shaped to have a test shaped pattern;
analyzing the test shaped pattern; and
adjusting a database to print the printed pattern on the plastic substrate based on the test shaped pattern.

11. The method of claim 10, wherein the test printed pattern includes grid lines.

12. The method of claim 7, further comprising:
supplying the plastic substrate from a supply roll prior to printing the printing medium on the plastic substrate;
winding the plastic substrate to a take-up roll subsequent to printing the printing medium on the plastic substrate; and
moving the plastic substrate from the supply roll to the take-up roll at a substantially constant rate.

13. The method of claim 12, further comprising feeding the plastic substrate from the take-up roll to the thermoforming device.

14. The method of claim 7, wherein indexing the plastic substrate comprises:
printing a timing mark on the plastic substrate relative to the printed pattern;
detecting the timing mark; and
stopping a movement of the plastic substrate relative to the thermoforming device in response to detecting the timing mark.

15. The method of claim 7, wherein a dyne level of the plastic substrate is greater than 40 dyn/cm.

16. A printed plastic object comprising:
a plastic substrate; and
a printed portion printed directly on a surface of the plastic substrate,
wherein the plastic substrate having the printed portion printed directly thereon is thermoformed to have a shape.

17. The printed plastic object of claim 16, wherein the printed portion comprises an ink having a thickness of 5 μm or less.

18. The printed plastic object of claim 16, wherein a dyne level of the plastic substrate is greater than 40 dyn/cm.

19. The printed plastic object of claim 16, wherein a thickness of the plastic substrate is greater than or equal to 0.008 inches.

20. The printed plastic object of claim 16, wherein the plastic substrate comprises a material selected from the group consisting of polyethylene terephthalate (PET), oriented polystyrene (OPS), styrene, polyvinyl chloride (PVC), and polypropylene.
